(19) United States
(12) Patent Application Publication
(10) Pub. No.: US 2019/0078910 A1
(43) Pub. Date: Mar. 14, 2019

(54) ACTUATOR WITH POSITION SENSOR ASSEMBLY

(71) Applicant: CTS Corporation, Lisle, IL (US)

(72) Inventors: Max Rolf James Viebach, Granger, IN (US); Kevin C. Wolschlager, Elkhart, IN (US); David C. Ajoku, Granger, IN (US); Randy P. Alexander, Goshen, IN (US); Han Yang, Granger, IN (US)

(73) Assignee: CTS Corporation, Lisle, IL (US)

(21) Appl. No.: 16/124,389

(22) Filed: Sep. 7, 2018

Related U.S. Application Data
(60) Provisional application No. 62/557,463, filed on Sep. 12, 2017.

(51) Int. Cl. G01D 5/14; F16H 61/32; G01B 7/00

(52) U.S. Cl. CPC G01D 5/145; G01P 3/487; G01B 7/003; F16H 61/32

(57) ABSTRACT

A vehicle component actuator comprising a housing, an actuator motor in the housing, and a rotatable output gear shaft assembly in the housing including a rotatable output shaft and gear. The output gear includes one or more discontinuities defined therein and each presenting a magnetic flux signature. A position sensor, including for example a Hall Effect position sensor with an integrated magnet, senses the magnetic flux signature of the one or more discontinuities on the output gear for sensing and determining the position of the output gear shaft assembly. The discontinuities can be of the same or different sizes/configuration and equally or unequally spaced from each other. The discontinuities can be slots or projections or any other feature presenting a unique magnetic flux signature that can be sensed by the position sensor.

### CROSS-REFERENCE TO RELATED APPLICATIONS

This patent application claims priority and benefit of the filing date of U.S. Provisional Patent Application Ser. No. 62/557,463 filed on Sep. 12, 2017, the disclosure and contents of which is expressly incorporated herein in its entirety by reference.

### FIELD OF THE INVENTION

This invention relates generally to an actuator and, more specifically to a vehicle component actuator with a position sensor assembly.

### BACKGROUND OF THE INVENTION

Actuators are used in the automotive industry to actuate vehicle engine components including for example the vanes of vehicle engine turbocharger assemblies.

Currently, the position of the actuator is determined via the use of a magnet coupled as by gluing or the like to the actuator output shaft in combination with a Hall Effect switch or sensor adapted to sense changes in the magnetic field generated by the magnet in response to movement of the actuator output shaft and allow the position of the actuator to be determined.

The present invention is directed to an actuator which uses an actuator position sensor assembly comprising in one embodiment a Hall Effect position sensor with an integrated magnet in combination with an output gear shaft including discontinuities with different magnetic flux signatures adapted for sensing by the Hall Effect position sensor.

### SUMMARY OF THE INVENTION

The present invention is generally directed to a vehicle component actuator comprising a housing, an actuator motor in the housing, a rotatable output gear shaft assembly in the housing including a rotatable output shaft and a rotatable output gear coupled to the rotatable output shaft for rotation therewith, the output gear including one or more discontinuities defined therein and each presenting a magnetic flux signature, and a position sensor adapted to sense the magnetic flux signature of the one or more discontinuities defined on the output gear for sensing and determining the position of the output gear shaft assembly.

In one embodiment, the output gear includes a plurality of discontinuities positioned equal distances from each other.

In one embodiment, the output gear includes a plurality of discontinuities positioned unequal distances from each other.

In one embodiment, the plurality of discontinuities comprise slots of the same size presenting the same magnetic flux signatures.

In one embodiment, the plurality of discontinuities comprise slots of different sizes presenting different magnetic flux signatures.

In one embodiment, the plurality of discontinuities comprise projections of the same size presenting the same magnetic flux signatures.

In one embodiment, the plurality of discontinuities comprise projections of different sizes presenting different magnetic flux signatures.

In one embodiment, the position sensor is mounted on a printed circuit board in a relationship spaced and overlying the output gear and the one or more discontinuities defined therein.

In one embodiment, the position sensor is a Hall Effect position sensor including an integrated magnet.

The present invention is also directed to a vehicle component actuator comprising a housing, an actuator motor in the housing, a rotatable output gear shaft assembly in the housing including a rotatable output shaft and a rotatable output gear coupled to the rotatable output shaft for rotation therewith, the output gear including a plurality of discontinuities each presenting a different magnetic flux signature, and a position sensor mounted on a printed circuit board and adapted to sense the magnetic flux signature of the plurality of discontinuities on the output gear for sensing and determining the position of the output gear shaft assembly.

In one embodiment, the discontinuities comprise differently sized slots in the output gear.

In one embodiment, the discontinuities comprise differently sized through-holes extending through the output gear.

In one embodiment, the discontinuities comprise differently sized projections protruding outwardly from the exterior surface of the output gear.

In one embodiment, the discontinuities comprise a combination of differently sized projections protruding outwardly from the exterior surface of the output gear and differently sized slots defined in the differently sized projections.

In one embodiment, the position sensor is a Hall Effect position sensor mounted on the printed circuit board in a relationship spaced from and overlying the plurality of discontinuities on the output gear.

Other advantages and features of the present invention will be more readily apparent from the following detailed description of the preferred embodiments of the invention, the accompanying drawings, and the appended claims.

### BRIEF DESCRIPTION OF THE DRAWINGS

These and other features of the invention can best be understood by the description of the accompanying FIGS as follows:

FIG. 1 is a perspective view of an actuator incorporating a position sensor assembly in accordance with the present invention;

FIG. 2 is an exploded perspective view of the actuator shown in FIG. 1;

FIG. 3 is a vertical cross-sectional view of the actuator shown in FIG. 1;

FIG. 4 is a top plan view of the output gear of the actuator shown in FIGS. 1-3;

FIG. 5 is a side elevational view of the output gear shown in FIG. 4;

FIG. 6 is a top plan view of another embodiment of the output gear of the actuator shown in FIGS. 1-3;

FIG. 7 is a side elevational view of the output gear shown in FIG. 6;

FIG. 8 is a top plan view of yet another embodiment of the output gear of the actuator shown in FIGS. 1-3; and

FIG. 9 is a side elevational view of the output gear shown in FIG. 8.

### DESCRIPTION OF THE EMBODIMENT

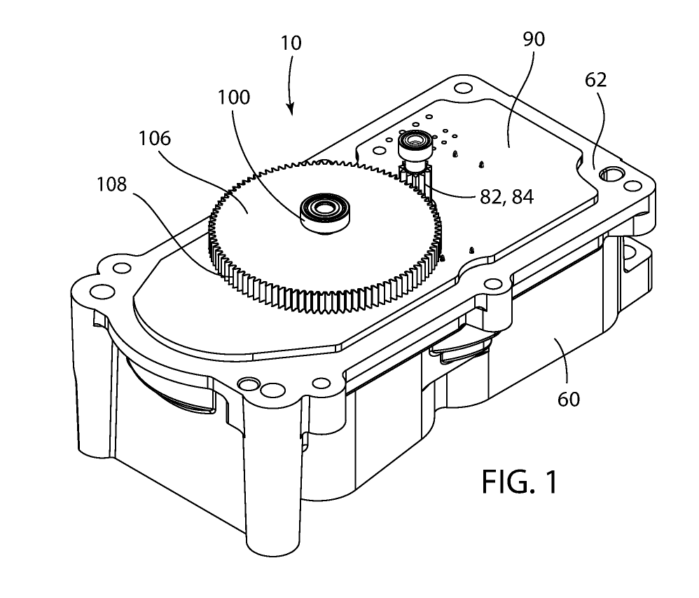

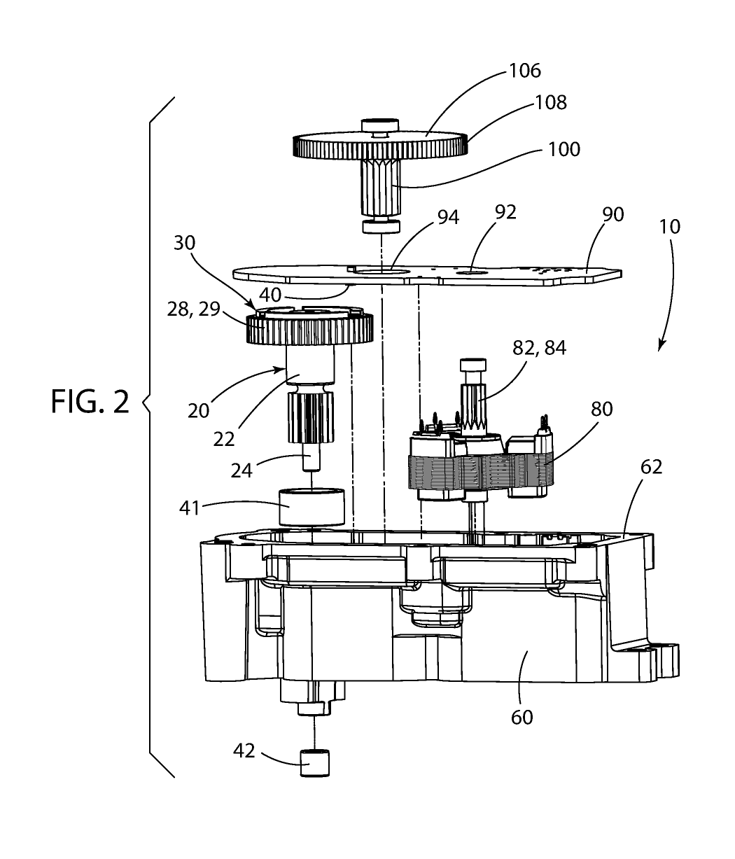

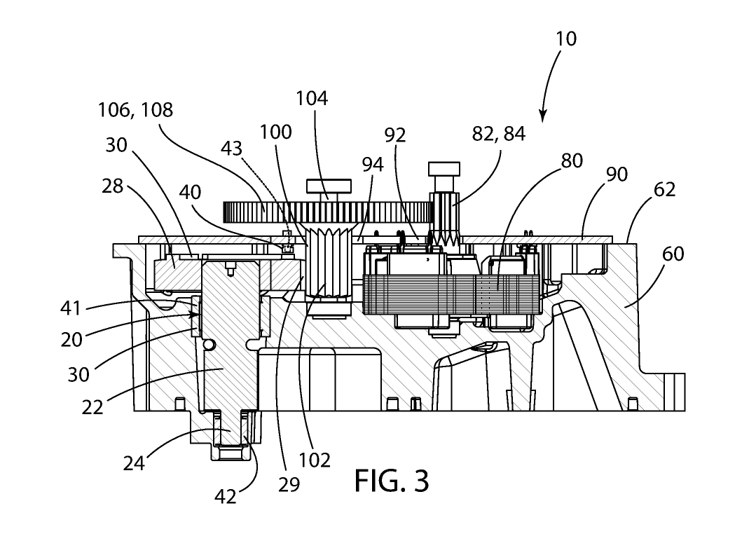

FIG. 1 depicts an actuator 10 incorporating an actuator position sensor assembly in accordance with the present invention which comprises, among other elements, a rotatable actuator output gear assembly 20 and a position sensor which in the embodiment shown is a stationary back bias Hall Effect integrated circuit sensor 40 located in the interior of an actuator housing 60 including an actuator electric motor 80.

In the embodiment shown, the actuator output gear assembly 20 includes an elongated vertical actuator output shaft 22 with a first distal end 24 adapted for coupling to the end of the shaft of a vehicle component (not shown) adapted to be actuated such as for example the shaft of a vehicle engine turbocharger (not shown) for moving the vanes of the turbocharger.

In the embodiment shown, the actuator output shaft 22 includes an end opposite the distal end 24 including a generally disc shaped toothed planetary output gear 28 oriented in a relationship generally normal to the actuator output shaft 22.

Bushings 41 and 42 in the interior of the actuator housing 60 surround the actuator output shaft 22 and mount the actuator output shaft 22 for rotation in the interior of the actuator housing 60.

The actuator 10 also comprises a vertical elongate motor output shaft 82 protruding outwardly from the actuator motor 80 and extending through an aperture 92 defined in a printed circuit board 90.

The actuator 10 further comprises an intermediate gear assembly including a vertical elongate shaft 100 extending through another aperture 94 in the printed circuit board 90 and including a first end 102 located in the interior of the actuator housing 60 and in toothed engagement with teeth 29 on the exterior surface of the output gear 28 and further including an end opposite the first end 102 extending through the aperture 94 and including an intermediate planetary gear 106 with exterior teeth 108 in engagement with teeth 84 on the exterior of the vertical motor output shaft 82.

In accordance with the operation of the actuator 10, the activation of the actuator motor 80 results in the rotation of the motor shaft 82 which in turn results in the rotation of the intermediate planetary gear 106 coupled to the motor shaft 82 which in turn results in the rotation of the intermediate gear shaft 100 coupled to the intermediate planetary gear 106 which in turn results in the rotation of the output planetary gear 28 coupled to the intermediate gear shaft 100 which in results in the rotation of the output shaft 22 coupled to the output planetary gear 28 which in turn results in the movement of the vehicle component gear (not shown) coupled to the end 24 of the output shaft 22.

In the embodiment shown, the printed circuit board 90 is seated against a top peripheral exterior edge 62 of the actuator housing 60 in a relationship overlying the output gear 28 and the actuator motor 80 located in the interior of the housing 60. The output gear 28 is situated and oriented in a relationship below, parallel and spaced from the printed circuit board 90. The output gear 28 is located on a first side of the printed circuit board 90 while the intermediate gear 106 is located on the second opposed side of the printed circuit board 90 in a relationship parallel and spaced from the printed circuit board 90. Thus, in the embodiment shown, the output gear 28 and the intermediate gear 106 are located on opposed sides of and spaced from the printed circuit board 90.

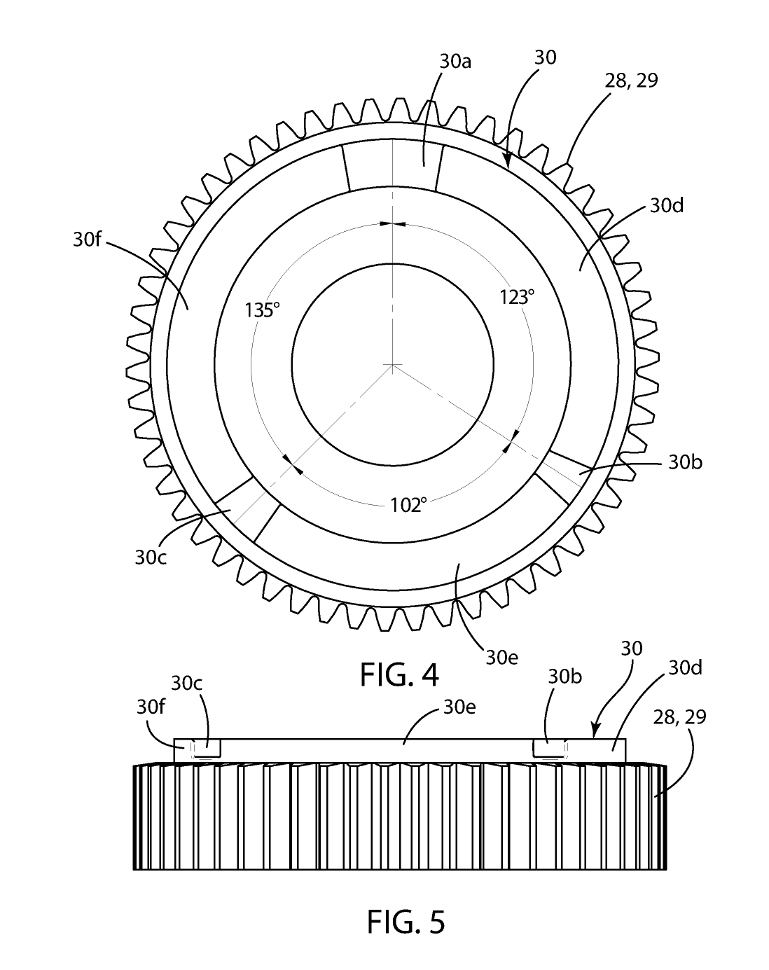

In accordance with the present invention, the top exterior face or surface of the gear 28 includes one or more discontinuities/changes in gear geometry 30 which, as shown in FIGS. 4 and 5, comprise a plurality of grooves, slots, or recesses 30a, 30b, and 30c formed in a plurality of protrusions 30d, 30e, and 30f protruding outwardly from the top exterior face or surface of the gear 28. The curvilinearly shaped discontinuities 30a, 30b, 30c, 30d, 30e, and 30f extend around the periphery of the exterior top surface of the gear 28.

In the embodiment shown, the grooves, slots, or recesses 30a, 30b, and 30c are of unequal/different size/configuration and more specifically of varying length and of equal width and depth and extend around the periphery of the gear 28 in unequal/different spaced angular increments of 102 degrees, 135 degrees, and 123 degrees. In the embodiment shown, each of the upwardly extending protrusions 30d, 30e, and 30f are curvilinear in shape and different size/configuration and, more specifically, of equal width and height but of unequal/different length.

It is understood however that, depending upon the particular application, the present invention encompasses embodiments with fewer or more of the grooves, slots, or recesses of equal or unequal/different width, length, and depth and extending around the periphery of the gear 28 in equal angular increments or fewer or more of the upwardly extending protrusions 30d, 30e, and 30f of unequal/different or equal width, height, or length.

In the embodiment shown, the position sensor which in the embodiment shown is a back bias Hall Effect integrated circuit sensor 40 is coupled to and extends outwardly from a lower exterior face or surface of the printed circuit board 80 in a relationship above, opposed and spaced from the discontinuities 30a, 30b, 30c, 30d, 30e, and 30f defined in the top exterior surface or face of the gear 28. The sensor 40 includes an integrated magnet 43. In another embodiment not shown, the position sensor 40 may be a suitable magneto resistive sensor.

In accordance with the present invention, the position of one or more of the discontinuities/changes/grooves 30a, 30b, 30c, 30d, 30e, and 30f is adapted to be detected or sensed by the back bias Hall Effect integrated circuit sensor 40 in response to the sensing of a change in the magnetic field generated by the integrated magnet 41 in response to a change in the position of the discontinuity/change in geometry 30 in response to a change in the rotational position of the gear 28 relative to the sensor 40.

More specifically, the sensing of the position of the discontinuity/change in geometry 30 in the gear 28 allows the sensor 40 to determine the position of the gear 28 and thus allows the position of the output shaft 22 and the vehicle component to be determined.

In the embodiment of FIGS. 4 and 5, the discontinuities 30a, 30b, 30c, 30d, 30e, and 30f are of different size/configuration presenting different unique magnetic flux signatures. Alternatively, the discontinuities 30a, 30b, 30c, 30d, 30e, and 30f can be of the same size/configuration presenting the same magnetic flux signatures.

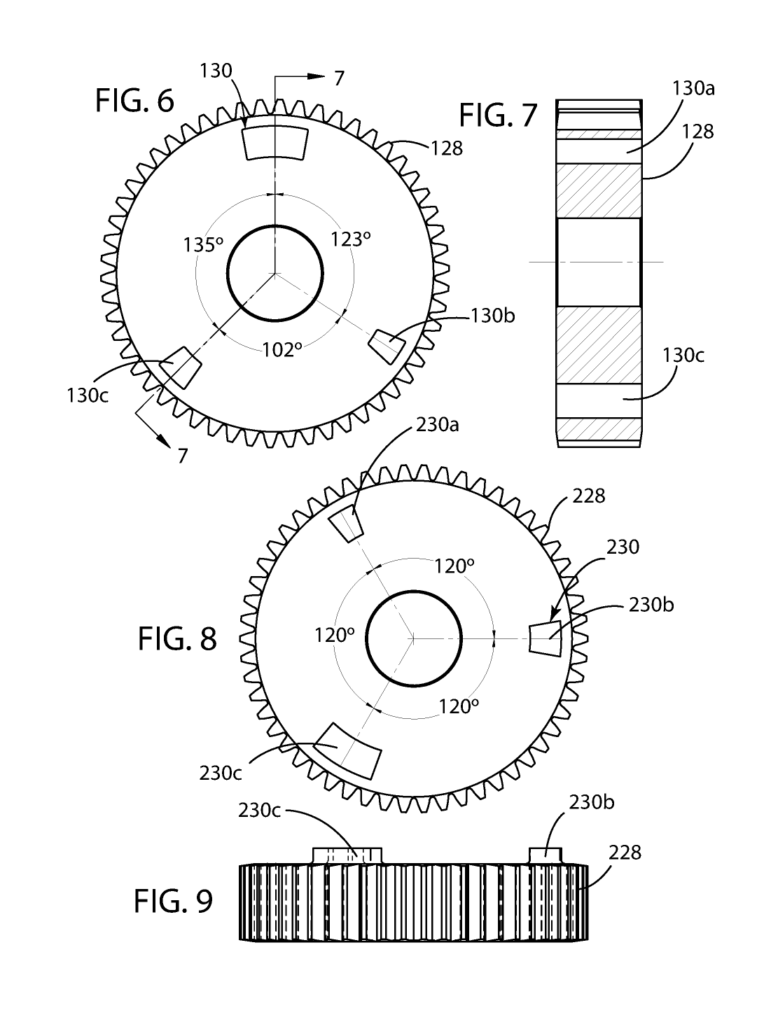

In accordance with the present invention, the discontinuities/changes in geometry 30 can be of any type including and presenting a different particular and unique magnetic flux signature that can be detected by the magnet 43 in the Hall Effect sensor 40 including, for example, slots, ledges, gear teeth, or the through-holes of the output gear embodiment shown in FIGS. 6 and 7.

FIGS. 6 and 7 depict another toothed gear embodiment 128 including a plurality of discontinuities/changes in gear geometry 130 in the form of a plurality of curvilinearly shaped through-holes 130a, 130b, and 130c extending through the interior of the body of the gear 128 and terminating in respective openings in the exterior top and bottom surfaces of the gear 128.

In the embodiment shown, the through-holes 130a, 130b, and 130c are of different size/configuration and, more specifically of varying/different length and of equal width and extend around the periphery of the gear 28 in unequal increments of 102 degrees, 135 degrees, and 123 degrees.

It is understood however that, depending upon the particular application, the present invention encompasses embodiments with fewer or more of the through-holes of equal or unequal/different width and length and extending around the periphery of the gear 28 in equal or unequal/different spaced angular increments.

Further, in accordance with the present invention, discontinuities, such as the discontinuities 130, which are unequally/differently spaced, sized, or otherwise unique from one another can be used to provide additional milestone information to allow for example the identification of key output gear positions including, for example, the home, 90 degree, and 270 degree positions of the output shaft 22 and output gear assembly 20.

Further, the present invention functions in both static and dynamic states, independent of angular speed, providing absolute position with each discontinuity included in the gear 28.

The Hall Effect sensor 40 may also include additional Hall plates to provide additional functionality including for example a 3 Hall plate design adapted to allow a determination of the direction of rotation of the gear 28 or a measurement/filtering of torsional vibration.

FIGS. 8 and 9 depict yet another embodiment of an output gear 228 in which the discontinuities/changes 230 in geometry comprise only curvilinearly shaped projections or segments or metal material 230a, 230b, and 230c projecting or protruding outwardly from the exterior top face or surface of the gear 228.

In the embodiment shown, the projections 230a, 230b, and 230c are of different size/configuration and, more specifically, of unequal/different length and equal width and height and extend around the periphery of the exterior face or surface of the gear 228 in equal angular spaced increments of 120 degrees to allow the measurement of three absolute output gear positions.

As with the earlier embodiments, each of the projections 230a, 230b, and 230c of different size/configuration presents and defines a particular and unique magnetic flux signature adapted to be sensed by the integrated Hall effect sensor magnet 43 when the gear 228 is rotated into a position in which the respective projections 230a, 230b, and 230c are positioned opposite and spaced from the Hall Effect sensor 40 and the integrated magnet 43. The magnetic flux signature in turn presents and defines a particular and unique sensor signal which in turn presents and defines a position of the gear 228 which in turn presents and defines a position of the actuator output shaft 22 and output gear assembly 20.

Numerous variations and modifications of the actuator described above may be effected without departing from the spirit and scope of the novel features of the invention. It is to be understood that no limitations with respect to the specific actuator and position sensor assembly assembly illustrated herein are intended or should be inferred. It is, of course, intended to cover by the appended claims all such modifications as fall within the scope of the claims.

What is claimed is:

1. A vehicle component actuator comprising:
a housing;
an actuator motor in the housing;
a rotatable output gear shaft assembly in the housing including a rotatable output shaft and a rotatable output gear coupled to the rotatable output shaft for rotation therewith, the output gear including one or more discontinuities defined therein and each presenting a magnetic flux signature; and
a position sensor adapted to sense the magnetic flux signature of the one or more discontinuities defined on the output gear for sensing and determining the position of the output gear shaft assembly.

2. The vehicle component actuator of claim 1 wherein the output gear includes a plurality of discontinuities positioned equal distances from each other.

3. The vehicle component actuator of claim 1 wherein the output gear includes a plurality of discontinuities positioned unequal distances from each other.

4. The vehicle component actuator of claim 1 wherein the plurality of discontinuities comprise slots of the same size presenting the same magnetic flux signatures.

5. The vehicle component actuator of claim 1 wherein the plurality of discontinuities comprise slots of different sizes presenting different magnetic flux signatures.

6. The vehicle component actuator of claim 1 wherein the plurality of discontinuities comprise projections of the same size presenting the same magnetic flux signatures.

7. The vehicle component actuator of claim 1 wherein the plurality of discontinuities comprise projections of different sizes presenting different magnetic flux signatures.

8. The vehicle component actuator of claim 1 wherein the position sensor is mounted on a printed circuit board in a relationship spaced and overlying the output gear and the one or more discontinuities defined therein.

9. The vehicle component actuator of claim 1 wherein the position sensor is a Hall Effect position sensor including an integrated magnet.

10. A vehicle component actuator comprising:
a housing;
an actuator motor in the housing;
a rotatable output gear shaft assembly in the housing including a rotatable output shaft and a rotatable output gear coupled to the rotatable output shaft for rotation therewith, the output gear including a plurality of discontinuities each presenting a different magnetic flux signature; and
a position sensor mounted on a printed circuit board and adapted to sense the magnetic flux signature of the plurality of discontinuities on the output gear for sensing and determining the position of the output gear shaft assembly.

11. The vehicle component actuator of claim 10 wherein the discontinuities comprise differently sized slots in the output gear.

12. The vehicle component actuator of claim 10 wherein the discontinuities comprise differently sized through-holes extending through the output gear.

13. The vehicle component actuator of claim 10 wherein the discontinuities comprise differently sized projections protruding outwardly from the exterior surface of the output gear.

14. The vehicle component actuator of claim 10 wherein the discontinuities comprise a combination of differently sized projections protruding outwardly from the exterior surface of the output gear and differently sized slots defined in the differently sized projections.

15. The vehicle component actuator of claim 10 wherein the position sensor is a Hall Effect position sensor mounted on the printed circuit board in a relationship spaced from and overlying the plurality of discontinuities on the output gear.
